(19) United States
(12) Patent Application Publication
(10) Pub. No.: US 2015/0066925 A1
(43) Pub. Date: Mar. 5, 2015

(54) Method and Apparatus for Classifying Data Items Based on Sound Tags

(71) Applicant: QUALCOMM INCORPORATED, San Diego, CA (US)

(72) Inventors: Min-Kyu Park, Seoul (KR); Taesu Kim, Seongnam (KR); Hyun-Mook Cho, Seoul (KR); Duck-Hoon Kim, Seoul (KR)

(73) Assignee: QUALCOMM INCORPORATED, San Diego, CA (US)

(21) Appl. No.: 14/011,437

(22) Filed: Aug. 27, 2013

(51) Int. Cl. G06F 17/30

(52) U.S. Cl. CPC G06F 17/30743; G06F 17/30598
USPC 707/737

(57) ABSTRACT

A method for grouping data items in a mobile device is disclosed. In this method, a plurality of data items and a sound tag associated with each of the plurality of data items are stored, and the sound tag includes a sound feature extracted from an input sound indicative of an environmental context for the data item. Further, the method may include generating a new data item, receiving an environmental sound, generating a sound tag associated with the new data item by extracting a sound feature from the environmental sound, and grouping the new data item with at least one of the plurality of data items based on the sound tags associated with the new data item and the plurality of data items.

### TECHNICAL FIELD

The present disclosure relates generally to classifying data items in mobile devices. More specifically, the present disclosure relates to classifying data items based on context information of mobile devices.

### BACKGROUND

In recent years, the use of mobile devices such as smartphones and tablet computers has become widespread. These devices typically allow users to perform a variety of functions such as data and/or voice communication, browsing the Internet, taking photographs or videos, uploading blog posts and SNS (Social Network Service) posts to the Internet, making phone or video calls, sending e-mails, text messages, and MMS messages, generating memos, etc. Due to such convenient features, users typically carry such a mobile device in person most of the time.

Conventional mobile devices are often used to capture data such as photographs, sound clips, etc. that can be stored in the mobile devices. In the case of photographs, such mobile devices may tag photographs with GPS (Global Positioning System) location information to indicate the locations where the photographs were taken. By using the GPS location information, photographs taken in a specified geographic location may be organized into a same group. In addition, photographs may also be tagged with time at which the photographs were taken. The photographs may then be organized according to the time information.

However, conventional mobile devices may capture data items in a variety of contexts. For example, photographs may be taken in a same location (e.g., a building) but have different contexts (e.g., a restaurant and a convenience store in a building). Also, photographs may be taken at different locations but in a similar context such as restaurants in different locations. In such cases, mobile devices may not be able to organize the photographs to sufficiently reflect similar or different contexts.

### SUMMARY

The present disclosure provides methods and apparatus for classifying data items based on a sound tag in mobile devices.

According to one aspect of the present disclosure, a method for grouping data items in a mobile device is disclosed. In this method, a plurality of data items and a sound tag associated with each of the plurality of data items are stored, and the sound tag includes a sound feature extracted from an input sound indicative of an environmental context for the data item. Further, the method may include generating a new data item, receiving an environmental sound, generating a sound tag associated with the new data item by extracting a sound feature from the environmental sound, and grouping the new data item with at least one of the plurality of data items based on the sound tags associated with the new data item and the plurality of data items. This disclosure also describes apparatus, a device, a system, a combination of means, and a computer-readable medium relating to this method.

According to another aspect of the present disclosure, a method for grouping data items in a mobile device is disclosed. This method includes generating a first data item, receiving a first environmental sound, and generating a first sound tag by extracting a first sound feature from the first environmental sound. Further, the method may include generating a second data item, receiving a second environmental sound, generating a second sound tag by extracting a second sound feature from the second environmental sound, and grouping the first and second data items based on the first and second sound tags. This disclosure also describes apparatus, a device, a system, a combination of means, and a computer-readable medium relating to this method.

According to still another aspect of the present disclosure, a mobile device includes a storage unit, a data item generator, a sound sensor, a sound tag generator, and a grouping unit. The storage unit is configured to store a plurality of data items and a sound tag associated with each of the plurality of data items, and the sound tag includes a sound feature extracted from an input sound indicative of an environmental context for the data item. The data item generator is configured to generate a new data item. The sound sensor is configured to receive an environmental sound. The sound tag generator is configured to generate a sound tag associated with the new data item by extracting a sound feature from the environmental sound. The grouping unit is configured to group the new data item with at least one of the plurality of data items based on the sound tags associated with the new data item and the plurality of data items.

According to yet another aspect of the present disclosure, a mobile device includes a data item generator, a sound sensor, a sound tag generator, and a grouping unit. The data item generator is configured to generate a first data item and a second data item. The sound sensor is configured to receive a first environmental sound and a second environmental sound. The sound tag generator is configured to generate a first sound tag by extracting a first sound feature from the first environmental sound and a second sound tag by extracting a second sound feature from the second environmental sound. The grouping unit is configured to group the first and second data items based on the first and second sound tags.

### BRIEF DESCRIPTION OF THE DRAWINGS

Embodiments of the inventive aspects of this disclosure will be understood with reference to the following detailed description, when read in conjunction with the accompanying drawings.

FIG. 1 illustrates a mobile device configured to group data items including a plurality of photographs, a memo, a blog post, and an SNS post generated in a specified geographical location based on environmental sounds, according to one embodiment of the present disclosure.

FIG. 2 illustrates a mobile device configured to group data items including a plurality of photographs, a memo, a blog post, and an SNS post generated in three different buildings, according to one embodiment of the present disclosure.

FIG. 3 illustrates a block diagram of a mobile device configured to generate and group data items by classifying the data items based on sound tags according to one embodiment of the present disclosure.

FIG. 4 is a flowchart of a method performed in a mobile device for grouping data items based on sound tags indicating environmental contexts according to one embodiment of the present disclosure.

FIG. 5 illustrates generating a sound tag including a sound feature, an audio group identifier, and a context label from an environmental sound according to one embodiment of the present disclosure.

FIG. 6 illustrates a flowchart of an exemplary method performed in a mobile device for extracting an audio fingerprint from an environmental sound as a sound feature according to one embodiment of the present disclosure.

FIG. 7 illustrates a flowchart of a method performed in a mobile device for extracting an MFCC vector from an environmental sound as a sound feature according to one embodiment of the present disclosure.

FIG. 8 illustrates a more detailed block diagram of a sound tag generator and a control unit in a mobile device for classifying or grouping data items by generating a sound tag including a sound feature, an audio group identifier, and a context label for each data item, according to one embodiment of the present disclosure.

FIG. 9 illustrates an exemplary tagged data item in which a data item is appended with a sound tag including a sound feature, an audio group identifier, and a context label, according to one embodiment of the present disclosure.

FIG. 10 illustrates grouping a selected data item with other data items by determining a similarity value between a sound feature associated with the selected data item and each sound feature associated with the other data items, according to one embodiment of the present disclosure.

FIG. 11 illustrates a selected data item and other data items displayed as a single group on a display screen of a mobile device, according to one embodiment of the present disclosure.

FIG. 12 is an exemplary context label database illustrating context labels for a plurality of input audio group identifiers according to one embodiment of the present disclosure.

FIG. 13 illustrates a plurality of groups of data items displayed on a display screen of a mobile device based on audio group identifiers in sound tags associated with the data items, according to one embodiment of the present disclosure.

FIG. 14 illustrates a plurality of groups of data items displayed on a display screen of a mobile device based on context labels in sound tags associated with the data items in another embodiment of the present disclosure.

FIG. 15 illustrates a block diagram of an exemplary mobile device in which the methods and apparatus for classifying data items based on a sound tag may be implemented according to some embodiments.

### DETAILED DESCRIPTION

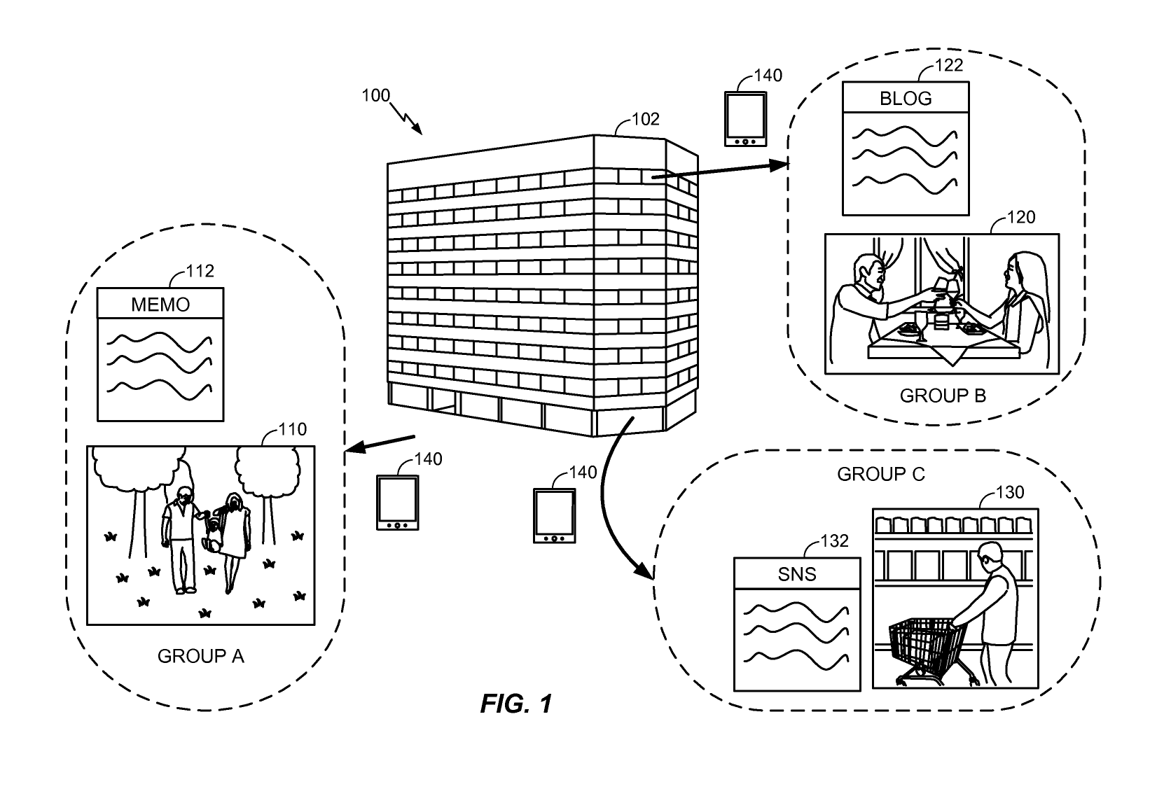

FIG. 1 illustrates a mobile device 140 configured to group data items including a plurality of photographs 110, 120, and 130, a memo 112, a blog post 122, and an SNS post 132 generated in a specified geographical location 100 based on environmental sounds, according to one embodiment of the present disclosure. As illustrated, the specified geographical location 100 is at or near a building 102 and may be classified or identified by the mobile device 140 as a same location. At various locations within the specified geographical location 100, a user may operate the mobile device 140 to generate the data items.

For each of the data items generated at various locations, the mobile device 140 may be configured to receive or capture an environmental sound to indicate the environmental context. In one embodiment, the mobile device 140 may be configured to capture an environmental sound associated with a data item for a predetermined period of time. Based on the captured environmental sound, a sound tag indicating an environmental context of the associated data item may be generated in the mobile device 140. The data items may then be classified by the mobile device 140 into a plurality of groups based on the sound tags.

In the illustrated embodiment, a user may operate the mobile device 140 in various locations within the specified geographic location 100 such as outdoors in front of the building 102, a restaurant inside the building 102, and a grocery market inside the building 102. The various locations may have different environmental contexts. In the outdoor case, the user operates the mobile device 140 to generate the data items including the photograph 110 and the memo 112. For each of these data items, the mobile device 140 may capture an environmental sound to generate a sound tag indicating an outdoor environment, which may include outdoor sounds such as wind noise, traffic sound, pedestrian sound, etc.

When the user is in the restaurant, the user may operate the mobile device 140 to generate the data items including the photograph 120 and the blog post 122. For each of these data items, the mobile device 140 may capture an environmental sound to generate a sound tag indicating a restaurant environment, which may include sounds such as sounds of utensils, music, food ordering, etc. In the case of the grocery market, the user may operate the mobile device 140 to generate the data items including the photograph 130 and the SNS post 132. For each of these data items, the mobile device 140 may capture an environmental sound to generate a sound tag indicating a grocery market environment, which may include sounds such as sounds of shopping carts, cash registers, announcements, etc.

Based on the sound tags, the mobile device 140 may classify or group the data items into groups A, B, and C according to the three different environmental contexts. For example, the data items including the photograph 110 and the memo 112 may be grouped together in group A according to the sound tags indicating the outdoor environment. On the other hand, the data items including the photograph 120 and the blog post 122 may be grouped in group B according to the sound tags indicating the restaurant environment, while the data items including photograph 130 and the SNS post 132 may be grouped together in group C according to the sound tags indicating the grocery market environment. Accordingly, data items of a same data type as well as data items of different data types, which are generated within the specified geographical location 100, may be grouped into different groups according to their environmental contexts.

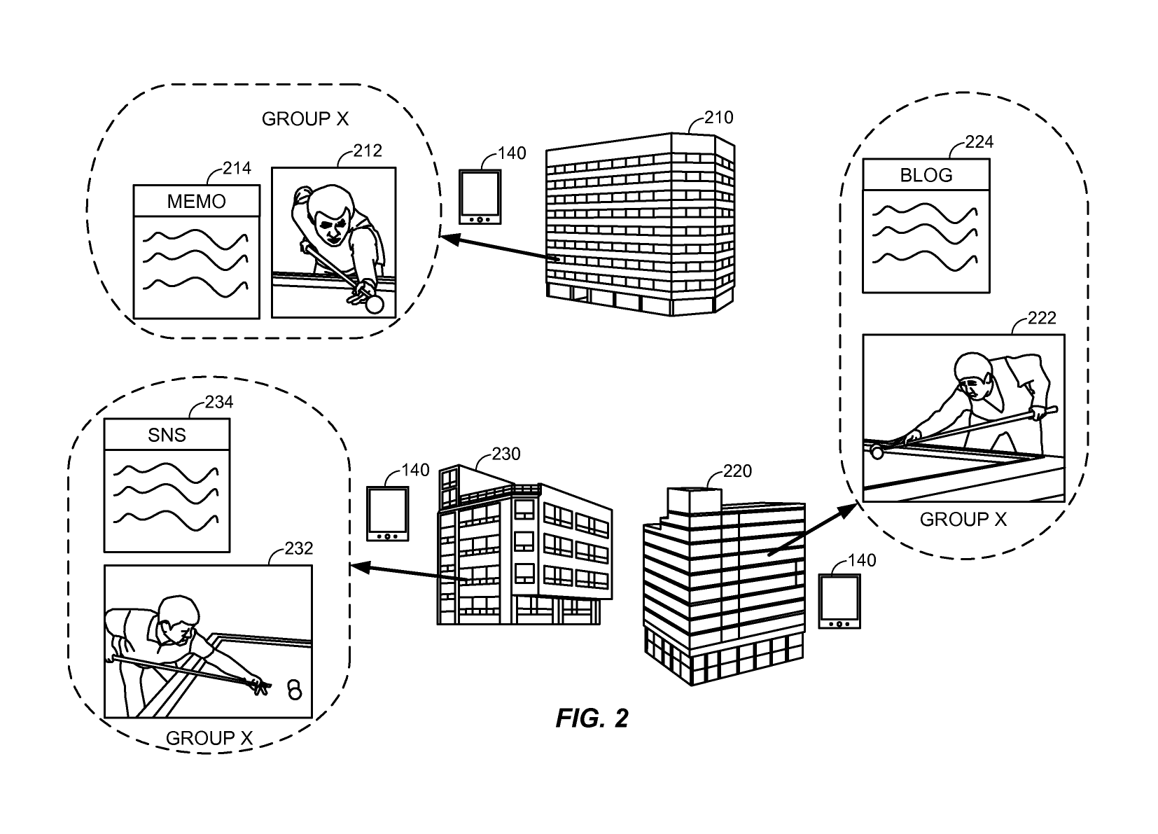

FIG. 2 illustrates the mobile device 140 configured to group data items including a plurality of photographs 212, 222, and 232, a memo 214, a blog post 224, and an SNS post 234 generated in three different buildings 210, 220, and 230, according to one embodiment of the present disclosure. The three buildings 210, 220, and 230 are located in three different geographical locations and are classified or identified by the mobile device 140 as being in different locations. The buildings 210, 220, and 230 may include premises with a similar environmental context.

As illustrated, the buildings 210, 220, and 230 include billiard rooms in which the user may operate the mobile device 140 to generate the data items having a similar environmental context (e.g., billiard room). In a billiard room located in the building 210, the user may operate the mobile device 140 to generate the data items including the photograph 212 and the memo 214. While in another billiard room located in the building 220, the user may operate the mobile device 140 to generate the data items including the photograph 222 and the blog post 224. Inside yet another billiard room within the building 230, the user may operate the mobile device 140 to generate the data items including the photograph 232 and the SNS post 234.

When each of the data items is generated, the mobile device 140 may capture an environmental sound for a predetermined period of time. The captured environmental sound may include sounds such as sounds of billiard balls striking each other, cue sticks, rolling billiard balls, etc. From the captured environmental sound, the mobile device 140 may generate a sound tag indicating a billiard environment for each of the data items. Based on the sound tags for the data items, the mobile device 140 may determine the data items as having a similar context of a billiard environment, and classify or group the data items, including the photographs 212, 222, and 232, the memo 214, the blog post 224, and the SNS post 234, into a same group X. In this manner, data items of a same data type as well as data items of different data types that are generated in different geographical locations may be grouped into a same group according to their environmental context.

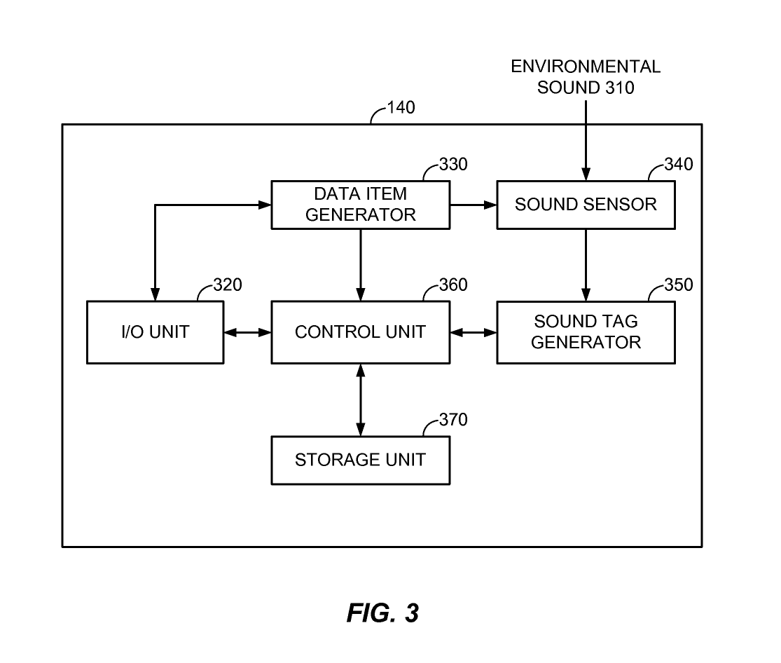

FIG. 3 illustrates a block diagram of the mobile device 140 configured to generate and group data items by classifying the data items based on sound tags according to one embodiment of the present disclosure. The mobile device 140 may include an I/O unit 320, a data item generator 330, a sound sensor 340, a sound tag generator 350, a control unit 360, and a storage unit 370. The mobile device 140 may be any suitable mobile device capable of generating a data item and equipped with a sound capturing and processing capability such as a cellular phone, a smartphone, a laptop computer, a tablet computer, a gaming device, a multimedia recorder/player, etc.

In the mobile device 140, the data item generator 330 may be activated in response to a first user input to activate the data item generator 330 via the I/O unit 320. In one embodiment, the data item generator 330 may be any application, device, or a combination thereof and includes a camera module, a camera application, an image capture application, a memo application, an SNS application, a blog generating application, a contact application, a phone application, an application execution log module, etc. While the data item generator 330 is activated, a data item may be generated in response to a second user input for generating the data item via the I/O unit 320. For example, a camera application may be activated by the first user input to initiate a preview mode and generate a photograph in response to the second user input. Similarly, a memo application may be activated by the first user input to initiate a memo editor and generate a memo according to the second user input. In another embodiment, the data item generator 330 may be configured to directly generate a data item in response to a single user input. Once the data item is generated, the data item generator 330 may provide the data item to the control unit 360.

As used herein, a data item may be any data representation of an object, file, or information in a specified format such as a photograph, a memo, an SNS post, a blog post, contact information, a call history, an application execution log, etc. In the case of the SNS post or the blog post, the data item may include basic information and a link to the on-line post since the contents of the on-line post are typically stored in an on-line server. The basic information such as a title, date of creation, a thumbnail of a representative picture, etc. may be output on the I/O unit 320, for example on a display screen, as a data item. Alternatively, the data item for the SNS post or the blog post may include the entire contents of the on-line post.

The sound sensor 340 may be activated to receive and capture an environmental sound 310 of the mobile device 140 for use in generating a sound tag indicative of an environmental context in which the data item is generated. When the data item generator 330 is activated, it may send a notification to the sound sensor 340 that a data item may be generated. If the sound sensor 340 has been inactive, the notification may activate the sound sensor 340. In response, the sound sensor 340 may capture the environmental sound 310 for a predetermined period of time.

In one embodiment, the sound sensor 340 may capture the environmental sound 310 for a predetermined period of time after the first user input. Alternatively, the sound sensor 340 may capture the environmental sound 310 for a predetermined period of time after the second user input. In the case of data items such as blog posts and SNS posts, the environmental sound 310 may be captured while the blog post or the SNS post is being composed by the user. In another embodiment, the sound sensor 340 may capture the environmental sound 310 for a predetermined period of time after the single user input. The sound sensor 340 may include one or more microphones or any other types of sound sensors that can be used to receive, capture, and/or convert the environmental sound 310 into digital data, and may employ any suitable software and/or hardware for performing such functions.

The sound tag generator 350 may be configured to receive the captured environmental sound 310 from the sound sensor 340 and generate a sound tag indicating an environmental context for the data item. The sound tag may include at least one of a sound feature, an audio group identifier, and a context label, as will be described in detail below. The sound tag generator 350 may then provide the sound tag to the control unit 360 for use in classifying or grouping the data item.

The control unit 360 may receive the data item and the associated sound tag from the data item generator 330 and the sound tag generator 350, respectively, and combine the sound tag with the data item. The data item and the sound tag may be combined by appending the sound tag to the data item. Alternatively, the sound tag may be linked with the data item using a pointer, a database table, etc., and stored together or separately in the storage unit 370. The control unit 360 may also classify the data item according to a context indicated in the sound tag. The data item combined with the sound tag may be stored in the storage unit 370. The storage unit 370 may be implemented using any suitable storage or memory devices such as a RAM (Random Access Memory), a ROM (Read-Only Memory), an EEPROM (Electrically Erasable Programmable Read-Only Memory), a flash memory, or an SSD (Solid State Drive).

The mobile device 140 may generate and store a plurality of data items and associated sound tags. In such cases, the control unit 360 may also access the data items and their sound tags from the storage unit 370 and group the data items into one or more groups based on their sound tags. For example, data items may be grouped into a same group when their sound tags indicate a similar environmental context. The control unit 360 may receive user inputs for generating or displaying data items as well as outputting data items, which have been generated or grouped, via the I/O unit 320 such as a touchscreen display.

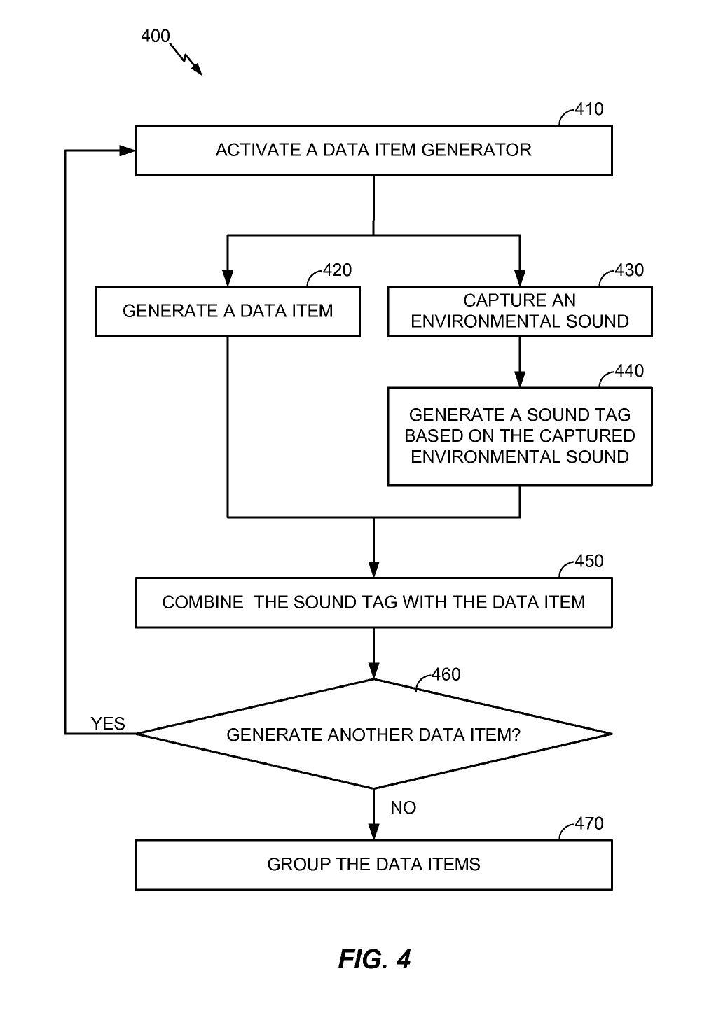

FIG. 4 is a flowchart of a method 400 performed in the mobile device 140 for grouping data items based on sound tags indicating environmental contexts according to one embodiment of the present disclosure. Initially, the data item generator 330 may be activated in response to receiving a first user input, at 410. The activated data item generator 330 may generate a data item in response to a second user input, at 420.

The sound sensor 340 may capture an environmental sound for a predetermined period of time at 430. The predetermined period of time is sufficient to identify an environmental context, in which the data item is generated. In one embodiment, the sound sensor 340 may be activated by a notification from the data item generator 330 indicating that a data item may be generated. At 440, the sound tag generator 350 may generate a sound tag for the data item indicating the environmental context based on the captured environmental sound. The data item may be generated at 420 while the environmental sound is captured at 430 or the sound tag is generated at 440. In some embodiments, the data item may be generated at 420 before the environmental sound is captured at 430 or after the sound tag is generated at 440. In another embodiment, at least a portion of the environmental sound may be captured during the time of generating the data item at 420.

Upon receiving the data item and the sound tag from the data item generator 330 and the sound tag generator 350, the control unit 360 may combine the sound tag with the data item at 450. The data item combined with the sound tag may be stored in the storage unit 370. Then, the method 400 proceeds to 460 to determine whether a new data item is to be generated. For example, when the mobile device 140 receives another second input via the I/O unit 320, it may be determined that the new data item is to be generated. If it is determined that the new data item is to be generated, the method 400 proceeds back to 420 to generate the new data item and also to 430 to capture a new environmental sound for the new data item. Otherwise, the method proceeds to 470 and the control unit 360 classifies or groups the data item generated at 420. In this case, the data item may be grouped with one or more data items stored in the storage unit 370 based on the associated sound tags.

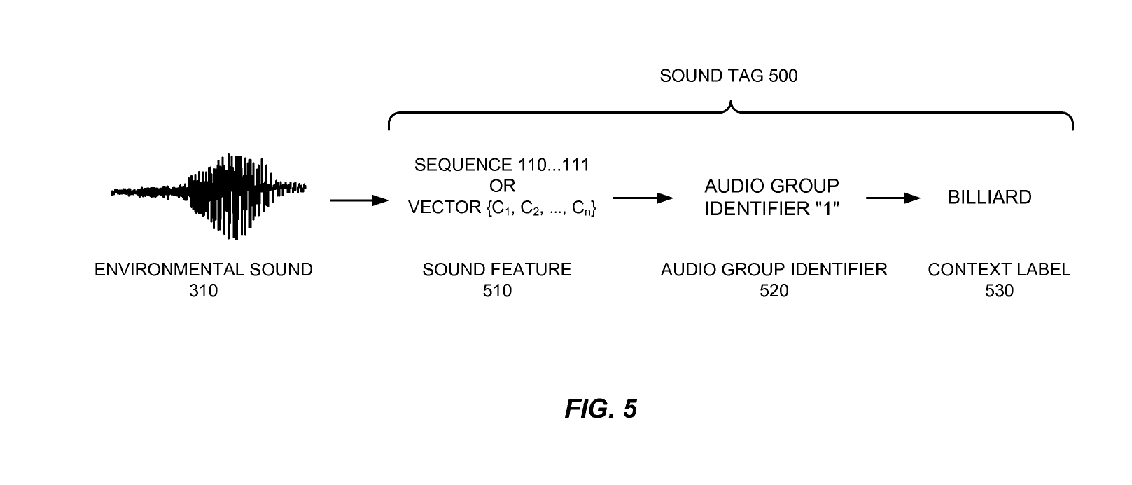

FIG. 5 illustrates generating a sound tag 500 including a sound feature 510, an audio group identifier 520, and a context label 530 from an environmental sound 310 according to one embodiment of the present disclosure. When the environmental sound 310 is received, the sound feature 510 may be extracted using any suitable feature extraction scheme such as an audio fingerprint method, an MFCC (Mel-frequency cepstral coefficients) method, etc. For example, the sound feature 510 may be represented as a sequence of m binary codes (e.g., “110 . . . 111”) in the case of the audio fingerprint method, and as a vector having n-dimensional values (e.g., vector {C₁, C₂, . . . , Cₙ}) in the case of the MFCC method. In some embodiments, the sound tag 500 may include a plurality of sound features, for example, a sound feature represented as an audio fingerprint and another sound feature represented as an MFCC vector.

In another embodiment, the audio group identifier 520 for the extracted sound feature 510 may be determined by accessing a reference audio group database. The reference audio group database may include a plurality of reference audio groups, each of which is associated with an audio group identifier. Each reference audio group may include statistical characteristics which can be generated through audio sample training. The reference audio group to which a sound feature belongs may be determined by using any algorithm adapted for identifying data groups such as the EM (Expectation Maximization) algorithm. For example, when the EM algorithm is used, a probability value of the sound feature belonging to each of the reference audio groups is calculated. After calculating the probability values, the reference audio group with the highest probability value is identified. The audio group identifier associated with the reference audio group with the highest probability value (e.g., audio group identifier “1”) is determined to be the audio group identifier 520 for the sound feature 510.

In still another embodiment, the context label 530 may be identified for the audio group identifier 520 by accessing a context label database. The context label database may include context labels for the audio group identifiers. The context labels may be assigned to the audio group identifiers based on the trained audio samples. Each of the context labels may be a text string or one or more words that identify an environmental context. For example, a context label “BILLIARD” may be identified for the audio group identifier “1” by accessing a lookup table in the context label database. As will be discussed in more detail below, some of the audio group identifiers may not have an assigned context label, for example, due to a lack of sufficient data for associating a context label to an audio group identifier.

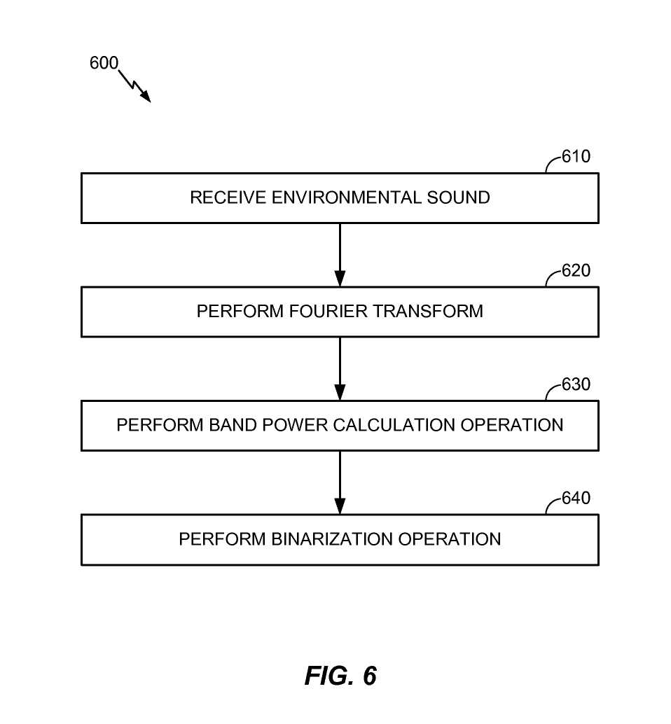

FIG. 6 illustrates a flowchart of an exemplary method 600 performed in the mobile device 140 for extracting an audio fingerprint from the environmental sound 310 as the sound feature 510 according to one embodiment of the present disclosure. Initially, the sound sensor 340 may receive the environmental sound 310 at 610. Typically, the environmental sound 310 is received in the form of a signal in the time domain. At 620, a Fourier transform operation may be performed on the environmental sound 310 to transform the time domain signal to a frequency domain signal. Then, at 630, the spectrum of the frequency domain signal may be divided into a plurality of frequency bands and a power of the signal may be calculated for each frequency band.

At 640, a binarization operation may be performed on each band power so that a binary value “1” is outputted when the band power exceeds a predetermined power, while a binary value “0” is outputted when the band power does not exceed the predetermined power. The binary values outputted at 640 may be used as the binary codes in the audio fingerprint. The method 600 illustrated in FIG. 6 is an exemplary method for extracting an audio fingerprint from the environmental sound 310, and any other suitable methods for extracting an audio fingerprint may be employed. Such methods may analyze various characteristics of the environmental sound 310, for example, average zero crossing rate, estimated tempo, average spectrum, spectral flatness, prominent tones across a set of bands, bandwidth, etc.

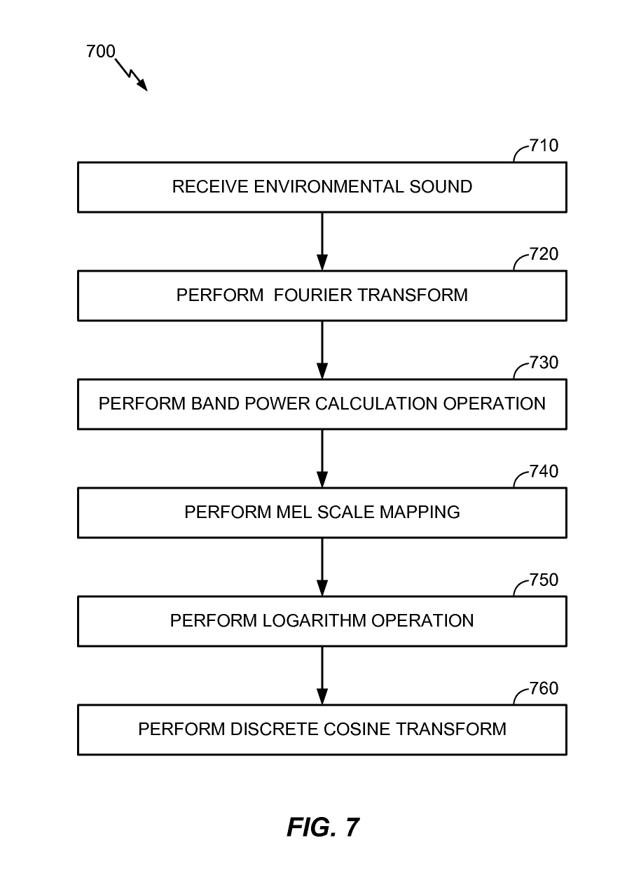

FIG. 7 illustrates a flowchart of a method 700 performed in the mobile device 140 for extracting an MFCC vector from the environmental sound 310 as the sound feature 510 according to one embodiment of the present disclosure. Initially, the sound sensor 340 may receive the environmental sound 310 at 710 in the form of a time domain signal. The time domain signal may be transformed to a frequency domain signal by performing a Fourier transform operation on the environmental sound 310 at 720. The spectrum of the frequency domain signal may be divided into a plurality of frequency bands and a power of the signal may be calculated for each frequency band, at 730.

At 740, the calculated band powers may be mapped onto the mel scale using triangular overlapping windows to generate mel frequencies. A logarithm operation may be performed on the mel frequencies to generate mel log powers at 750, and a DCT (discrete cosine transform) operation may then be performed on the mel log powers to generate DCT coefficients at 760. The generated DCT coefficients may be used as components in the MFCC vector.

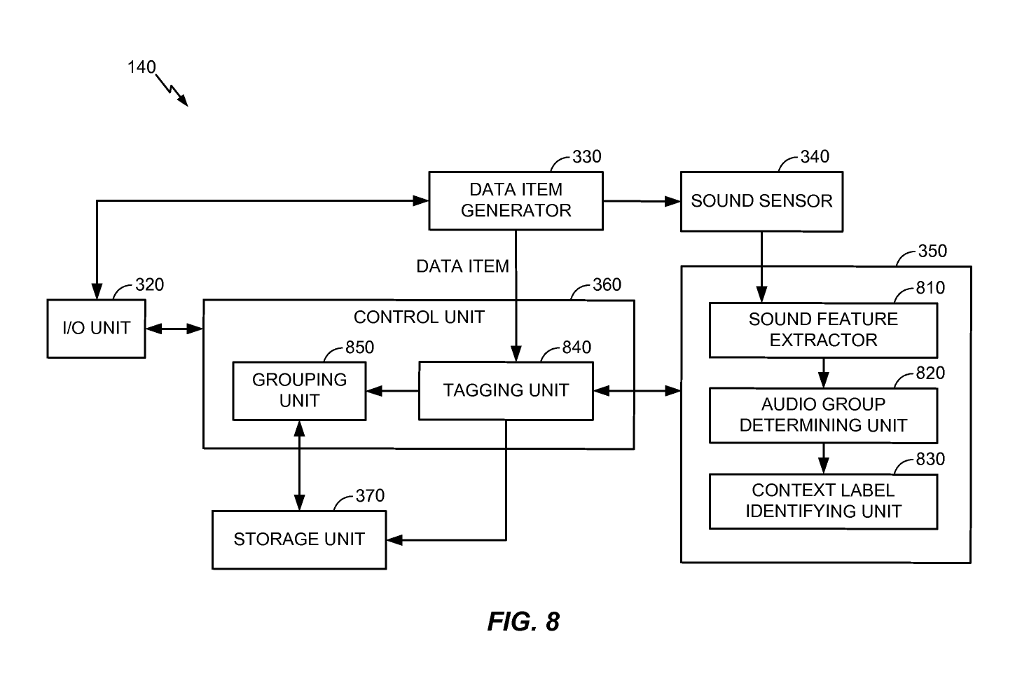

FIG. 8 illustrates a more detailed block diagram of the sound tag generator 350 and the control unit 360 in the mobile device 140 for classifying or grouping data items by generating a sound tag including a sound feature, an audio group identifier, and a context label for each data item, according to one embodiment of the present disclosure. The sound tag generator 350 may include a sound feature extractor 810, an audio group determining unit 820, and a context label identifying unit 830. The control unit 360 may include a tagging unit 840 and a grouping unit 850. The mobile device 140 may also include the I/O unit 320, the data item generator 330, the sound sensor 340, and the storage unit 370, as described above with reference to FIG. 3.

When the data item generator 330 is activated for generating a data item in response to a user input, the sound sensor 340 may also be activated to receive and capture an environmental sound for a predetermined period of time. The sound feature extractor 810 in the sound tag generator 350 may receive the captured environmental sound from the sound sensor 340 and extract a sound feature from the received environmental sound. In the sound feature extractor 810, any suitable feature extraction method such as an audio fingerprinting method, an MFCC (Mel-frequency cepstral coefficients) method, etc. may be used to extract the sound feature from the received environmental sound. The sound feature extractor 810 may then provide the extracted sound feature to the audio group determining unit 820.

Upon receiving the sound feature from the sound feature extractor 810, the audio group determining unit 820 may access a reference audio group database in the storage unit 370. The reference audio group database may include a plurality of reference audio groups, each of which is associated with an audio group identifier. The audio group determining unit 820 may determine a reference audio group to which the sound feature belongs and output the associated audio group identifier.

The reference audio group to which a sound feature belongs may be determined by using any algorithm adapted for identifying data groups such as the EM (Expectation Maximization) algorithm. For example, when the EM algorithm is used, the audio group determining unit 820 calculates a probability value of the sound feature belonging to each of the reference audio groups. After calculating the probability values, the audio group determining unit 820 identifies the reference audio group with the highest probability value. The audio group determining unit 820 then provides the audio group identifier associated with the reference audio group with the highest probability value to the context label identifying unit 830.

The context label identifying unit 830 may receive the audio group identifier from the audio group determining unit 820 and access a context label database from the storage unit 370. The context label database may include context labels for the audio group identifiers. Each of the context labels may be a text string or one or more words that identify an environmental context (e.g., restaurant environment, billiard environment, stadium environment, etc.). As will be discussed in more detail below, some of the audio group identifiers may not have an assigned context label, for example, due to a lack of sufficient data for associating a context label to an audio group identifier. The context label identifying unit 830 may then identify the context label associated with the received audio group identifier in the context label database and output the identified context label.

The sound tag generator 350 may generate the sound tag that indicates an environmental context of the associated data item. In one embodiment, the sound tag generator 350 may generate a sound tag that includes at least one of the sound feature, the audio group identifier, and the context label and provide the sound tag to the tagging unit 840 in the control unit 360. Alternatively, the sound tag generator 350 may provide at least one of the sound feature, the audio group identifier, and the context label to the tagging unit 840 to be used as a sound tag.

When a data item associated with the sound tag is generated in the data item generator 330, the tagging unit 840 in the control unit 360 may receive the data item from the data item generator 330. In addition, the tagging unit 840 may receive the sound tag for the data item including at least one of the sound feature, the audio group identifier, and the context label from the sound tag generator 350. In one embodiment, the data item and the sound tag may then be combined and output as a tagged data item by the tagging unit 840. In another embodiment, at least one of the sound feature, the audio group identifier, and the context label may be received from the sound tag generator 350 and appended to the data item as a sound tag by the tagging unit 840.

The data item may be classified into a group based on the appended sound tag. For example, the data item may be classified into a group according to the audio group identifier or the context label in the appended sound tag. The data item appended with the sound tag may be provided to the storage unit 370 for storage and/or to the grouping unit 850 to be grouped with one or more tagged data items that may be stored in the storage unit 370.

In the control unit 360, the grouping unit 850 may receive the tagged data item from the tagging unit 840 for grouping with one or more other tagged data items accessed from the storage unit 370. Alternatively, the tagged data item may have been stored in the storage unit 370 by the tagging unit 840. In this case, the grouping unit 850 may access the tagged data item along with other tagged data items stored in the storage unit 370 and group the tagged data items based on their sound tags. The grouping unit 850 may group the tagged data items based on any one or combination of a sound feature, an audio group identifier, and a context label in the sound tags. The control unit 360 may also group the data items for output via the I/O unit 320 in response to a user input.

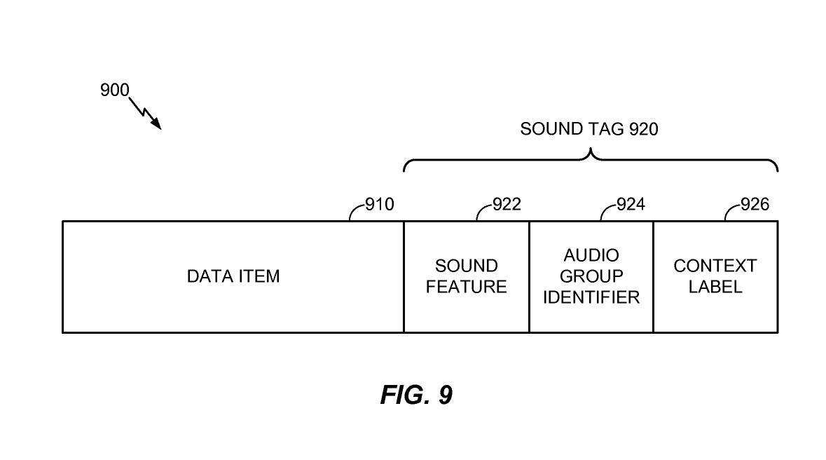

FIG. 9 illustrates an exemplary tagged data item 900 in which a data item 910 is appended with a sound tag 920 including a sound feature 922, an audio group identifier 924, and a context label 926, according to one embodiment of the present disclosure. The sound feature 922, the audio group identifier 924, and the context label 926 may, individually or in combination, indicate an environmental context of the data item 910. Although the illustrated sound tag 920 includes the sound feature 922, the audio group identifier 924, and the context label 926, the sound tag 920 may also be configured to include any one or a combination of the sound feature 922, the audio group identifier 924, and the context label 926. In addition, the appended order of the data item 910, the sound feature 922, the audio group identifier 924, and the context label 926 is not limited to the example of FIG. 9 and may be properly determined.

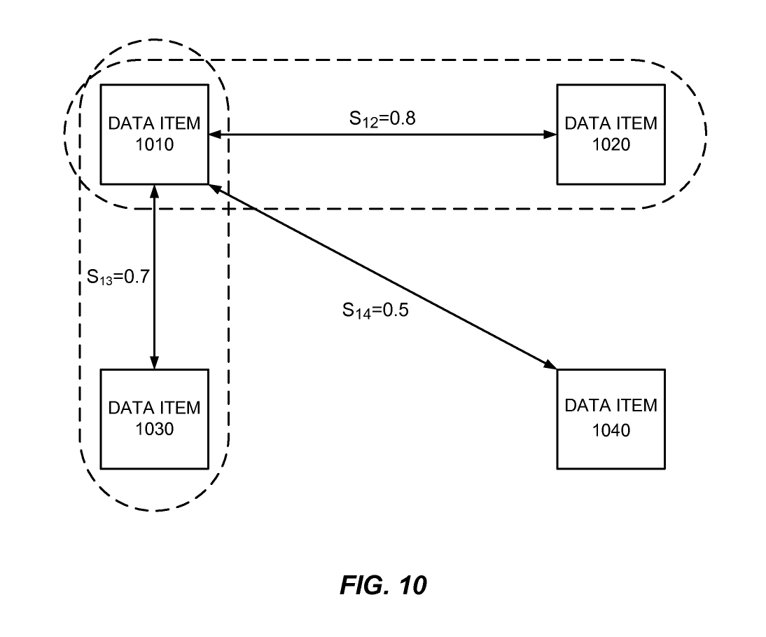

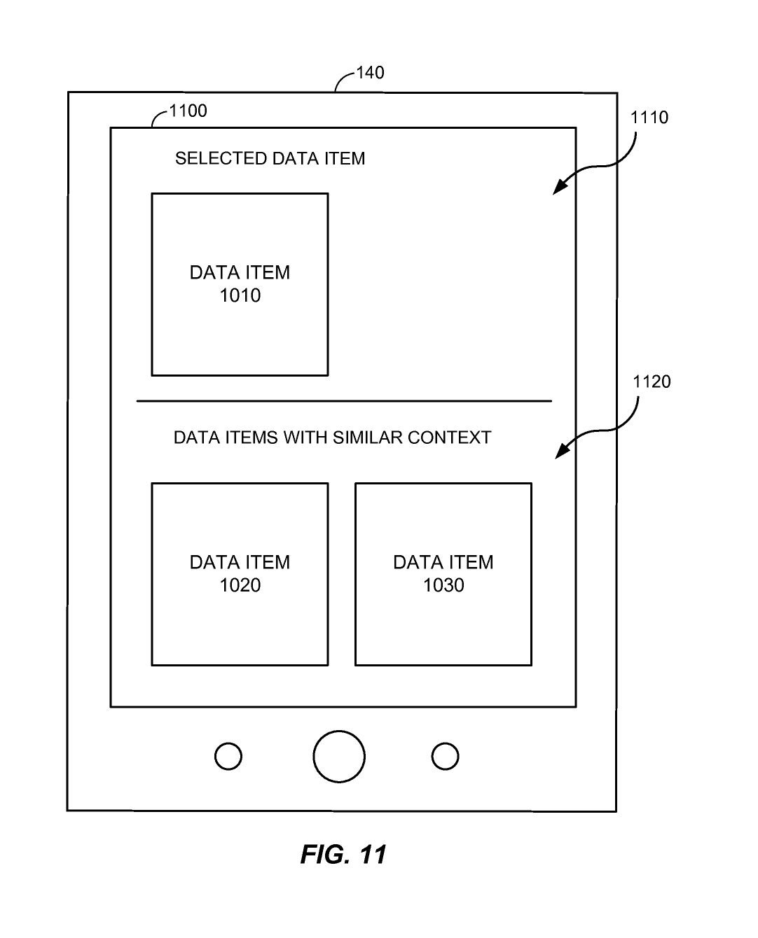

In one embodiment, when a plurality of tagged data items has been generated in the mobile device 140, they may be grouped based on sound features in the associated sound tags. For example, sound features for a pair of data items may be compared to calculate a similarity value. If the calculated similarity value exceeds a predetermined similarity threshold, the two data items may be determined to be similar to each other as will be described in more detail with reference to FIGS. 10 and 11.

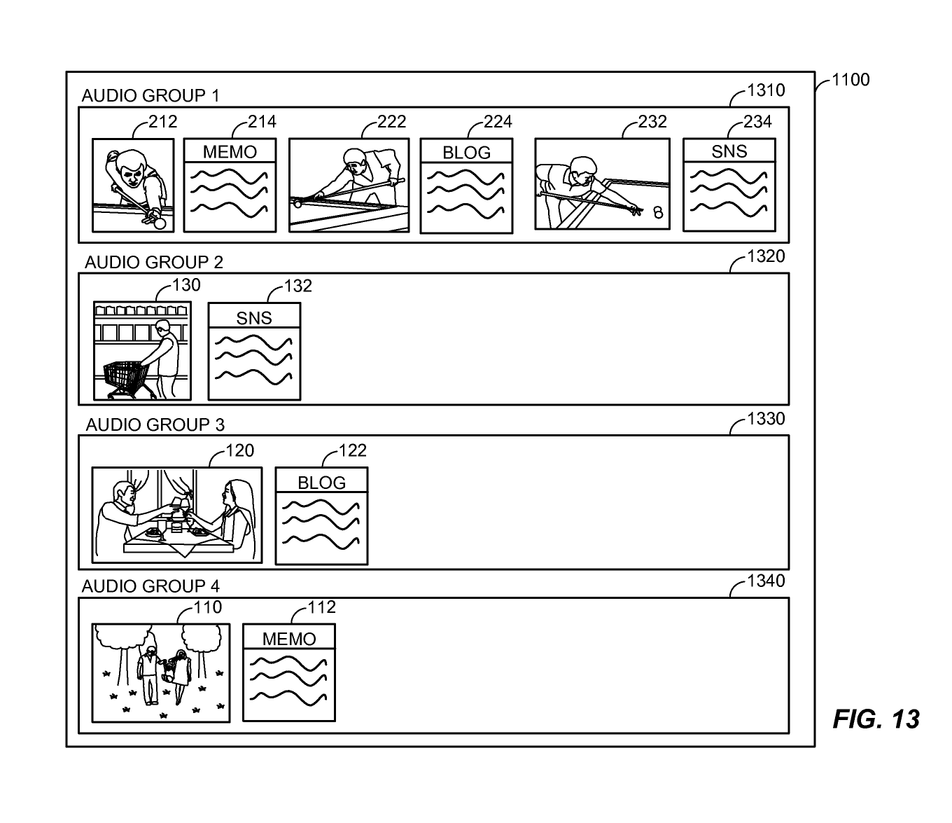

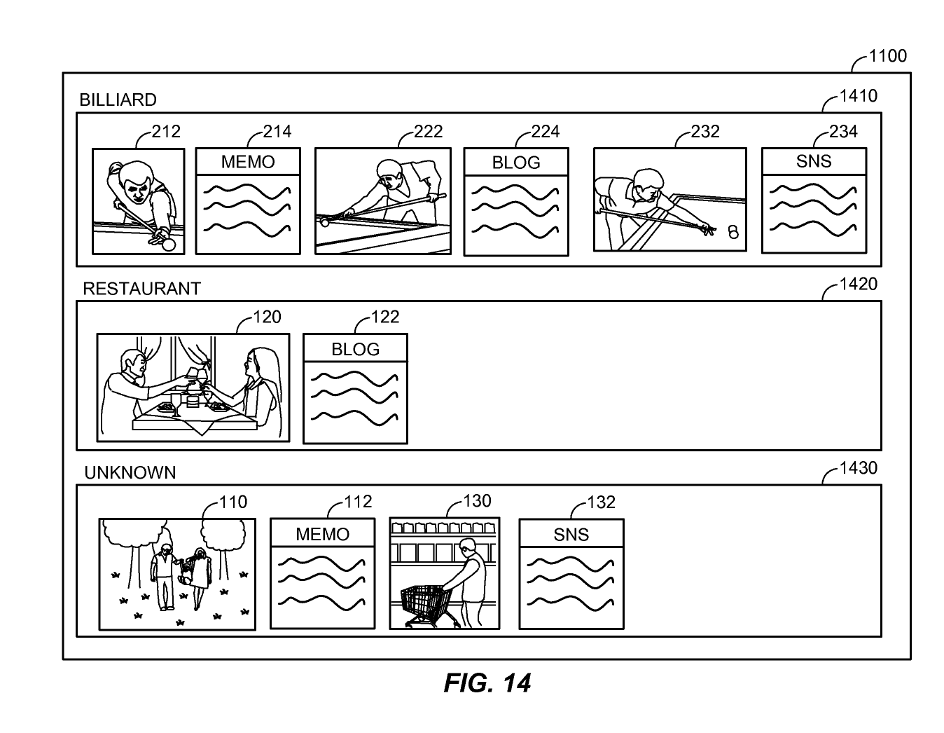

In another embodiment, a plurality of data items may be classified or grouped into a same group based on the associated audio group identifiers. In this case, data items having the same audio group identifier may be classified into a same group. The plurality of data items may also be classified or grouped based on the associated context labels. In this case, data items that have the same context label may be grouped together. Classifying and grouping of data items based on the associated audio group identifiers and context labels are described in more in detail with reference to FIGS. 13 and 14 below.

FIG. 10 illustrates grouping a selected data item 1010 with other data items 1020, 1030, and 1040 by determining a similarity value between a sound feature associated with the selected data item 1010 and each sound feature associated with the data items 1020 to 1040, according to one embodiment of the present disclosure. Initially, the data item 1010 to be grouped may be selected when it is generated or in response to a user input. For each of the data items 1020, 1030, and 1040, a similarity value between the sound feature of the selected data item 1010 and the sound feature associated with the data item 1020, 1030, or 1040 may be calculated.

A similarity value between a pair of sound features may be calculated by employing any suitable distance metrics such as Mahalonobis distance, p-norm distance, Hamming distance, Euclidean distance, Manhattan distance, Chebyshev distance, etc. For example, in the case of audio fingerprints used as sound features, a similarity value may be determined by calculating a Hamming distance between a pair of audio fingerprints, and taking a multiplicative inverse of the distance. In the case of using MFCC vectors as sound features, a similarity value may be determined by calculating a Euclidean distance between a pair of MFCC vectors, and taking a multiplicative inverse of the distance.

Once a similarity value has been determined for a pair of data items, the similarity value may be compared to a predetermined similarity threshold. If the similarity value exceeds the threshold, the two data items may be determined to have a similar environmental context and thus are grouped into a same group. On the other hand, if the similarity value does not exceed the threshold, the data items may be considered to have different environmental contexts and are not grouped into a same group.

In the illustrated embodiment, similarity values between the sound feature associated with the data item 1010 and the sound features of the data items 1020 to 1030 are determined and compared with a similarity threshold value which is predetermined to be, for example, 0.6. The determined similarity value between the sound features of the data items 1010 and 1020 (i.e., S₁₂) is 0.8, which is greater than the predetermined similarity threshold. Thus, the data items 1010 and 1020 may be determined to have a similar environmental context and can be grouped together. For the sound features of the data items 1010 and 1030, the determined similarity value (i.e., S₁₃) of 0.7 is greater than the predetermined similarity threshold. Accordingly, the data items 1010 and 1030 are also determined to have a similar environmental context and can be grouped into a same group. On the other hand, the similarity value between the sound features of the data items 1010 and 1040 (i.e., S₁₄) is 0.5, which is smaller than the predetermined value 0.6. Thus, data items 1010 and 1040 are determined to have different environmental contexts and are not grouped together. Based on the above grouping, the data items 1010, 1020, and 1030 may be grouped and displayed as a single group.

FIG. 11 illustrates the selected data item 1010 and the data items 1020 and 1030 displayed as a single group on a display screen 1100 of the mobile device 140, according to one embodiment of the present disclosure. As illustrated, the selected data item 1010 may be displayed on an upper portion 1110 of the display screen 1100 of the mobile device 140. The data items 1020 and 1030 may be displayed as having a similar context as the selected data item 1110 in a lower portion 1120 of the display screen 1100. In this manner, the mobile device 140 may group and display a data item with other data items having similar context based on sound features extracted from captured environmental sounds.

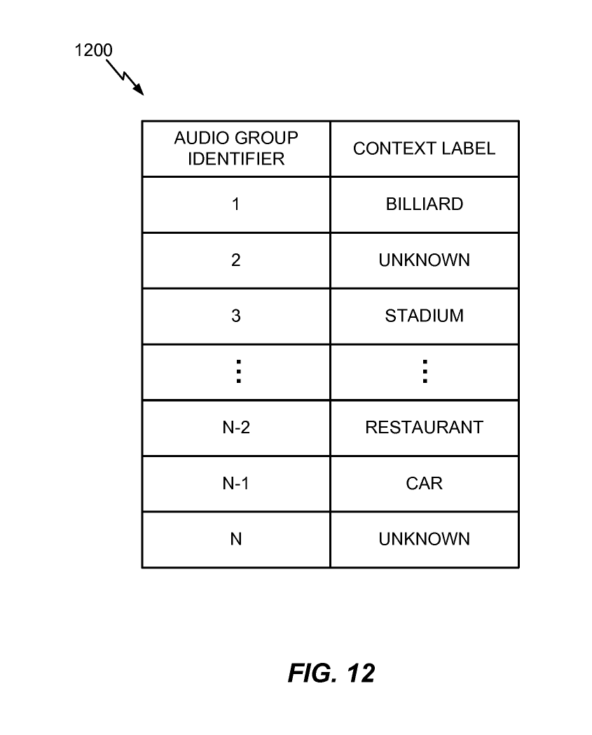

FIG. 12 is an exemplary context label database 1200 illustrating context labels for a plurality of input audio group identifiers according to one embodiment of the present disclosure. The context label database 1200 may include N context labels associated with N audio group identifiers. In the illustrated embodiment, context labels “BILLIARD,” “STADIUM,” “RESTAURANT,” and “CAR” are associated with audio group identifiers “1,” “3,” “N−2,” and “N−1,” respectively. The context label database 1200 may be implemented as a lookup table or any other data structure that associates audio group identifiers with context labels.

As described above with reference to FIG. 8, the context label identifying unit 830 may access the context label database 1200 based on an audio group identifier and identify a context label associated with the audio group identifier. For example, when an audio group identifier “3” is received, the context label identifying unit 830 identifies and outputs the context label “STADIUM.” Similarly, the context label “RESTAURANT” may be output for the audio group identifier “N−2.”

In the context label database 1200, if a unique context label is not available for an audio group identifier (e.g., audio group identifiers “2” and “N”), a context label “UNKNOWN” may be assigned. In one embodiment, data items having the context label “UNKNOWN” may be classified and grouped into a same group. In this manner, data items may be classified and grouped according to their context labels.

FIG. 13 illustrates a plurality of groups of data items 1310, 1320, 1330, and 1340 displayed on the display screen 1100 of the mobile device 140 based on audio group identifiers in sound tags associated with the data items, according to one embodiment of the present disclosure. As described with reference to FIGS. 1 and 2 above, the plurality of photographs 212, 222, and 232, the memo 214, the blog post 224, and the SNS post 234 are generated in a billiard environment and are combined with the same audio group identifier (e.g., audio group identifier “1” in FIG. 12). Accordingly, the data items 212, 214, 222, 224, 232, and 234 may be grouped and displayed as the first group of data items 1310.

The photograph 130 and the SNS post 132 are generated in a grocery market environment and are combined with the same audio group identifier. Thus, the data items 130 and 132 may be grouped and displayed as the second group of data items 1320. The photograph 120 and the blog post 122 are generated in a restaurant environment and are combined with the same audio group identifier. Therefore, the data items 120 and 122 may be grouped and displayed as the third group of data items 1330. The photograph 110 and the memo 112 are generated in an outdoor environment and are combined with the same audio group identifier. Accordingly, the data items 110 and 112 may be grouped and displayed as the fourth group of data items 1340.

In one embodiment, each of the groups 1310 to 1340 may be displayed with an audio group number to distinguish the groups 1310 to 1340 (e.g., “AUDIO GROUP 1” to “AUDIO GROUP 4” as illustrated in FIG. 13). Additionally or alternatively, a context label associated with each of the audio group identifiers for the groups 1310 to 1340 may be displayed on the display screen 1100 of the mobile device 140. For example, the context labels “BILLIARD” and “RESTAURANT” may be displayed above the first and third groups of data items 1310 and 1330 while the context label “UNKNOWN” may be displayed above the second and fourth groups of data items 1320 and 1340.

FIG. 14 illustrates a plurality of groups of data items 1410, 1420, and 1430 displayed on the display screen 1100 of the mobile device 140 based on context labels in sound tags associated with the data items in another embodiment of the present disclosure. As described with reference to FIGS. 1 and 2 above, the plurality of photographs 212, 222, and 232, the memo 214, the blog post 224, and the SNS post 234 are generated in a billiard environment and are combined with the context label “BILLIARD.” Accordingly, the data items 212, 214, 222, 224, 232, and 234 may be grouped and displayed as the first group of data items 1410. The photograph 120 and the blog post 122 are generated in a restaurant environment and are combined with the same context label “RESTAURANT.” Thus, the data items 120 and 122 may be grouped and displayed as the second group of data items 1420.

In the illustrated example of FIG. 14, the photograph 110 and the memo 112 are generated in an outdoor environment and are combined with the context label “UNKNOWN.” Further, the photograph 130 and the SNS post 132 are generated in a grocery market environment and are combined with the context label “UNKNOWN.” Although the audio group identifiers for the data items 110 and 112 may be different from the audio group identifier for the data items 130 and 132, the different audio group identifiers are associated with the same context label “UNKNOWN.” Thus, the data items 110, 112, 130, and 132 may be grouped according to the same context label “UNKNOWN” and displayed together in the third group of data items 1430. As illustrated in FIG. 14, each of the groups 1410 to 1430 may be displayed with the context labels (e.g., “BILLIARD,” “RESTAURANT,” and “UNKNOWN”) to distinguish the groups 1410 to 1430.

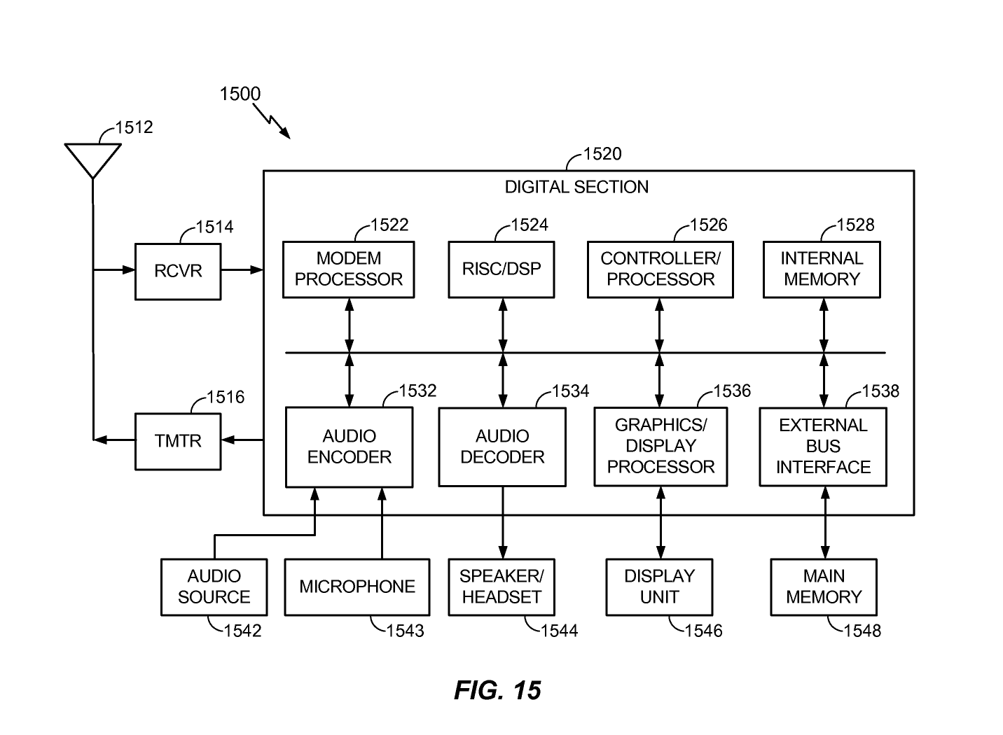

FIG. 15 illustrates a block diagram of a mobile device 1500 in a wireless communication system in which the methods and apparatus for classifying or grouping data items may be implemented according to some embodiments of the present disclosure. The mobile device 1500 may be a cellular phone, a terminal, a handset, a personal digital assistant (PDA), a wireless modem, a cordless phone, a tablet, and so on. The wireless communication system may be a Code Division Multiple Access (CDMA) system, a Global System for Mobile Communications (GSM) system, a Wideband CDMA (W-CDMA) system, a Long Term Evolution (LTE) system, a LTE Advanced system, and so on.

The mobile device 1500 may be capable of providing bidirectional communication via a receive path and a transmit path. On the receive path, signals transmitted by base stations are received by an antenna 1512 and are provided to a receiver (RCVR) 1514. The receiver 1514 conditions and digitizes the received signal and provides the conditioned and digitized signal to a digital section 1520 for further processing. On the transmit path, a transmitter (TMTR) receives data to be transmitted from a digital section 1520, processes and conditions the data, and generates a modulated signal, which is transmitted via the antenna 1512 to the base stations. The receiver 1514 and the transmitter 1516 is part of a transceiver that supports CDMA, GSM, W-CDMA, LTE, LTE Advanced, and so on.

The digital section 1520 includes various processing, interface, and memory units such as, for example, a modem processor 1522, a reduced instruction set computer/digital signal processor (RISC/DSP) 1524, a controller/processor 1526, an internal memory 1528, a generalized audio encoder 1532, a generalized audio decoder 1534, a graphics/display processor 1536, and/or an external bus interface (EBI) 1538. The modem processor 1522 performs processing for data transmission and reception, e.g., encoding, modulation, demodulation, and decoding. The RISC/DSP 1524 performs general and specialized processing for the mobile device 1500. The controller/processor 1526 controls the operation of various processing and interface units within the digital section 1520. The internal memory 1528 stores data and/or instructions for various units within the digital section 1520.

The generalized audio encoder 1532 performs encoding for input signals from an audio source 1542, a microphone 1543, and so on. The generalized audio decoder 1534 performs decoding for coded audio data and provides output signals to a speaker/headset 1544. It should be noted that the generalized audio encoder 1532 and the generalized audio decoder 1534 are not necessarily required for interface with the audio source, the microphone 1543 and the speaker/headset 1544, and thus are not shown in the mobile device 1500. The graphics/display processor 1536 performs processing for graphics, videos, images, and texts, which is presented to a display unit 1546. The EBI 1538 facilitates transfer of data between the digital section 1520 and a main memory 1548.

The digital section 1520 is implemented with one or more processors, DSPs, microprocessors, RISCs, etc. The digital section 1520 is also fabricated on one or more application specific integrated circuits (ASICs) and/or some other type of integrated circuits (ICs).

In general, any device described herein is indicative of various types of devices, such as a wireless phone, a cellular phone, a laptop computer, a wireless multimedia device, a wireless communication personal computer (PC) card, a PDA, an external or internal modem, a device that communicates through a wireless channel, and so on. A device may have various names, such as access terminal (AT), access unit, subscriber unit, mobile station, client device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein are implemented by various means. For example, these techniques are implemented in hardware, firmware, software, or combinations thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For hardware implementation, the processing units used to perform the techniques are implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein are implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein are applied to other variations without departing from the spirit or scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for grouping data items in a mobile device, the method comprising:
storing a plurality of data items and a sound tag associated with each of the plurality of data items, the sound tag including a sound feature extracted from an input sound indicative of an environmental context for the data item;
generating a new data item;
receiving an environmental sound;
generating a sound tag associated with the new data item by extracting a sound feature from the environmental sound; and
grouping the new data item with at least one of the plurality of data items based on the sound tags associated with the new data item and the plurality of data items.

2. The method of claim 1, wherein generating the sound tag associated with the new data item comprises determining an audio group identifier for the extracted sound feature.

3. The method of claim 2, wherein generating the sound tag associated with the new data item further comprises identifying a context label for the audio group identifier.

4. The method of claim 1, wherein grouping the new data item with at least one of the plurality of data items comprises:
selecting one of the plurality of data items;
calculating a similarity value between the sound feature associated with the new data item and the sound feature associated with the selected data item; and
if the similarity value exceeds a threshold, grouping the new data item and the selected data item.

5. The method of claim 2, wherein grouping the new data item with at least one of the plurality of data items comprises grouping the new data item with the at least one of the plurality of data items based on the audio group identifier.

6. The method of claim 3, wherein grouping the new data item with at least one of the plurality of data items comprises grouping the new data item with the at least one of the plurality of data items based on the context label.

7. The method of claim 1, further comprising displaying the grouped data items including the new data item and the at least one of the plurality of data items on the mobile device.

8. The method of claim 1, wherein the environmental sound is received for a predetermined time period.

9. The method of claim 8, wherein at least a portion of the environmental sound is received during the time of generating the new data item.

10. The method of claim 1, wherein the sound feature is an audio fingerprint or a MFCC vector.

11. The method of claim 1, wherein each of the plurality of data items and the new data item is one of a photograph, an SNS post, a blog post, a memo, contact information, a call history, and an application execution history.

12. The method of claim 1, wherein the grouped data items include data items of different data types.

13. A method for grouping data items in a mobile device, the method comprising:
generating a first data item;
receiving a first environmental sound;
generating a first sound tag by extracting a first sound feature from the first environmental sound;
generating a second data item;
receiving a second environmental sound;
generating a second sound tag by extracting a second sound feature from the second environmental sound; and
grouping the first and second data items based on the first and second sound tags.

14. The method of claim 13, wherein generating the first sound tag comprises determining a first audio group identifier for the first sound feature, and
wherein generating the second sound tag comprises determining a second audio group identifier for the second sound feature.

15. The method of claim 14, wherein generating the first sound tag further comprises identifying a first context label for the first audio group identifier, and
wherein generating the second sound tag further comprises identifying a second context label for the second audio group identifier.

16. The method of claim 13, wherein grouping the first and second data items comprises:
calculating a similarity value between the first sound feature and the second sound feature; and
if the similarity value exceeds a threshold, grouping the first and second data items.

17. The method of claim 14, wherein grouping the first and second data items comprises grouping the first and second data items based on the first and second audio group identifiers.

18. The method of claim 15, wherein grouping the first and second data items comprises grouping the first and second data items based on the first and second context labels.

19. The method of claim 13, wherein data types of the first and second data items are different.

20. A mobile device, comprising:
a storage unit configured to store a plurality of data items and a sound tag associated with each of the plurality of data items, the sound tag including a sound feature extracted from an input sound indicative of an environmental context for the data item;
a data item generator configured to generate a new data item;
a sound sensor configured to receive an environmental sound;
a sound tag generator configured to generate a sound tag associated with the new data item by extracting a sound feature from the environmental sound; and
a grouping unit configured to group the new data item with at least one of the plurality of data items based on the sound tags associated with the new data item and the plurality of data items.

21. The mobile device of claim 20, wherein the sound tag generator is further configured to determine an audio group identifier for the extracted sound feature.

22. The mobile device of claim 21, wherein the sound tag generator is further configured to identify a context label for the audio group identifier.

23. The mobile device of claim 20, wherein the grouping unit is further configured to:
select one of the plurality of data items;
calculate a similarity value between the sound feature associated with the new data item and the sound feature associated with the selected data item; and
if the similarity value exceeds a threshold, group the new data item and the selected data item.

24. The mobile device of claim 21, wherein the grouping unit is further configured to group the new data item with the at least one of the plurality of data items based on the audio group identifier.

25. The mobile device of claim 22, wherein the grouping unit is further configured to group the new data item with the at least one of the plurality of data items based on the context label.

26. The mobile device of claim 20, further comprising an output unit configured to display the grouped data items including the new data item and the at least one of the plurality of data items.

27. The mobile device of claim 20, wherein the environmental sound is received for a predetermined time period.

28. The mobile device of claim 27, wherein at least a portion of the environmental sound is received during the time of generating the new data item.

29. The mobile device of claim 20, wherein the sound feature is an audio fingerprint or a MFCC vector.

30. The mobile device of claim 20, wherein each of the plurality of data items and the new data item is one of a photograph, an SNS post, a blog post, a memo, contact information, a call history, and an application execution history.

31. The mobile device of claim 20, wherein the grouped data items include data items of different data types.

32. A mobile device, comprising:
a data item generator configured to generate a first data item and a second data item;
a sound sensor configured to receive a first environmental sound and a second environmental sound;
a sound tag generator configured to generate a first sound tag by extracting a first sound feature from the first environmental sound and a second sound tag by extracting a second sound feature from the second environmental sound; and
a grouping unit configured to group the first and second data items based on the first and second sound tags.

33. The mobile device of claim 32, wherein the sound tag generator is further configured to:
determine a first audio group identifier for the first sound feature; and
determine a second audio group identifier for the second sound feature.

34. The mobile device of claim 33, wherein the sound tag generator is further configured to:
identify a first context label for the first audio group identifier; and
identify a second context label for the second audio group identifier.

35. The mobile device of claim 32, wherein the grouping unit is further configured to:
calculate a similarity value between the first sound feature and the second sound feature; and
if the similarity value exceeds a threshold, group the first and second data items.

36. The mobile device of claim 33, wherein the grouping unit is further configured to group the first and second data items based on the first and second audio group identifiers.

37. The mobile device of claim 34, wherein the grouping unit is further configured to group the first and second data items based on the first and second context labels.

38. The mobile device of claim 32, wherein data types of the first and second data items are different.

39. A mobile device, comprising:
means for storing a plurality of data items and a sound tag associated with each of the plurality of data items, the sound tag including a sound feature extracted from an input sound indicative of an environmental context for the data item;
means for generating a new data item;
means for receiving an environmental sound;
means for generating a sound tag associated with the new data item by extracting a sound feature from the environmental sound; and
means for grouping the new data item with at least one of the plurality of data items based on the sound tags associated with the new data item and the plurality of data items.

40. The mobile device of claim 39, wherein the means for generating the sound tag is configured to determine an audio group identifier for the extracted sound feature.

41. The mobile device of claim 40, wherein the means for generating the sound tag is further configured to identify a context label for the audio group identifier.

42. The mobile device of claim 39, wherein the means for grouping the new data item with at least one of the plurality of data items is configured to:
select one of the plurality of data items;
calculate a similarity value between the sound feature associated with the new data item and the sound feature associated with the selected data item; and
if the similarity value exceeds a threshold, group the new data item and the selected data item.

43. The mobile device of claim 39, wherein the grouped data items include data items of different data types.

44. A mobile device, comprising:
means for generating a first data item and a second data item;
means for receiving a first environmental sound and a second environmental sound;
means for generating a first sound tag by extracting a first sound feature from the first environmental sound and a second sound tag by extracting a second sound feature from the second environmental sound; and
means for grouping the first and second data items based on the first and second sound tags.

45. The mobile device of claim 44, wherein the means for generating the first sound tag and the second sound tag is configured to:
determine a first audio group identifier for the first sound feature; and
determine a second audio group identifier for the second sound feature.

46. The mobile device of claim 45, wherein the means for generating the first sound tag and the second sound tag is further configured to:
identify a first context label for the first audio group identifier; and
identify a second context label for the second audio group identifier.

47. The mobile device of claim 44, wherein the means for grouping the first and second data items is configured to:
calculate a similarity value between the first sound feature and the second sound feature; and
if the similarity value exceeds a threshold, group the first and second data items.

48. The mobile device of claim 44, wherein data types of the first and second data items are different.

49. A non-transitory computer-readable storage medium storing instructions for grouping data items in a mobile device, the instructions causing a processor to perform operations of:
storing a plurality of data items and a sound tag associated with each of the plurality of data items, the sound tag including a sound feature extracted from an input sound indicative of an environmental context for the data item;
generating a new data item;
receiving an environmental sound;
generating a sound tag associated with the new data item by extracting a sound feature from the environmental sound; and
grouping the new data item with at least one of the plurality of data items based on the sound tags associated with the new data item and the plurality of data items.

50. The medium of claim 49, wherein generating the sound tag associated with the new data item comprises determining an audio group identifier for the extracted sound feature.

51. The medium of claim 50, wherein generating the sound tag associated with the new data item further comprises identifying a context label for the audio group identifier.

52. The medium of claim 49, wherein grouping the new data item with at least one of the plurality of data items comprises:
selecting one of the plurality of data items;
calculating a similarity value between the sound feature associated with the new data item and the sound feature associated with the selected data item; and
if the similarity value exceeds a threshold, grouping the new data item and the selected data item.

53. The medium of claim 49, wherein the grouped data items include data items of different data types.

54. A non-transitory computer-readable storage medium storing instructions for grouping data items in a mobile device, the instructions causing a processor to perform operations of:
generating a first data item;
receiving a first environmental sound;
generating a first sound tag by extracting a first sound feature from the first environmental sound;
generating a second data item;
receiving a second environmental sound;
generating a second sound tag by extracting a second sound feature from the second environmental sound; and
grouping the first and second data items based on the first and second sound tags.

55. The medium of claim 54, wherein generating the first sound tag comprises determining a first audio group identifier for the first sound feature, and
wherein generating the second sound tag comprises determining a second audio group identifier for the second sound feature.

56. The medium of claim 55, wherein generating the first sound tag further comprises identifying a first context label for the first audio group identifier, and
wherein generating the second sound tag further comprises identifying a second context label for the second audio group identifier.

57. The medium of claim 54, wherein grouping the first and second data items comprises:
calculating a similarity value between the first sound feature and the second sound feature; and
if the similarity value exceeds a threshold, grouping the first and second data items.

58. The medium of claim 54, wherein data types of the first and second data items are different.
